(19) United States
(12) Patent Application Publication
(10) Pub. No.: US 2008/0133431 A1
(43) Pub. Date: Jun. 5, 2008

(54) Method and Apparatus to Facilitate Determining a Monetary Cost Associated with Supporting a Communication Session Using Heterogeneous Network Communication Resources

(75) Inventors: Paul R. Hancock, Barrington, IL (US); Charles D. Gavrilovich, Park Ridge, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/832,997

(22) Filed: Aug. 2, 2007

Related U.S. Application Data
(63) Continuation-in-part of application No. 11/564,950, filed on Nov. 30, 2006.

(51) Int. Cl. G06F 17/00

(52) U.S. Cl. 705/400; 705/7

(57) ABSTRACT

A network server (200) (prior to initiation of a communication session by a particular mobile device (205), which mobile device will be moving from a first location to a second location and thereby traversing heterogeneous network communication resources (204)) is able to automatically determine (103) a monetary cost associated with supporting a communication service using heterogeneous network communication resources as that mobile device moves from a first location to a second location. By one approach, this can comprise, at least in part, automatically determining (102) a sequence of usage of the heterogeneous network communication resources by which the communication session can be supported as the mobile device moves from the first to the second location (in which case, if desired, the step of determining the monetary cost can be made, at least in part, as a function of that sequence of usage).

### RELATED APPLICATIONS

This application comprises a continuation-in-part of an earlier filed U.S. Patent Application entitled METHOD AND APPARATUS TO FACILITATE USING A PATH TO DYNAMICALLY SCHEDULE WIRELESS ACCESS POINT SUPPORT FOR A GIVEN COMMUNICATION SESSION as was filed by the present applicant and inventors on Nov. 30, 2006 as application Ser. No. 11/564,950, the contents of which are further fully incorporated herein by this reference.

### TECHNICAL FIELD

This invention relates generally to the use of heterogeneous network communication resources and more particularly to cost determinations as pertain to such usage.

### BACKGROUND

Communication networks of various kinds are known in the art including a wide (and seemingly ever growing) variety of wireless communications networks. In many cases, however, adjacent, proximal, and/or overlapping communications networks are heterogeneous (that is, such networks are not fully operationally compatible with one another in that differences exist with respect to, for example, physical communications layer requirements, administrative requirements, and so forth). To support increased transparent mobility with respect to the usage of such disparate network communications resources, many mobile devices now exhibit considerable agility in this regard and are able to accommodate compatible interaction with a variety of such heterogeneous networks.

That a given mobile device has a physical capability of operating compatibly with respect to a plurality of heterogeneous network communication resources, however, does not necessarily address all extant circumstances of potential interest. In many cases, for example, the monetary cost of using such resources can and will vary (and sometimes vary considerably) from one resource or network to another. Such variances can differ greatly with respect to a wide variety of influences including, but not limited to, a given mobile device's pre-existing administrative relationship with a given network, a time and/or duration of usage, a type or level of usage, a given priority of usage, and so forth.

In some instances, a given mobile device user may wish to initiate a communication session that will span, during the course of that session, a plurality of heterogeneous network communications resources but will also require, for example, that this session not exceed a given maximum monetary cost. At present, such information is either simply unattainable or, if available, represents, at best, nothing more than a rough estimate that will often prove to be egregiously incorrect in practice.

### BRIEF DESCRIPTION OF THE DRAWINGS

The above needs are at least partially met through provision of the method and apparatus to facilitate determining a monetary cost associated with supporting a communication session using heterogeneous network communication resources described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a network server (prior to initiation of a communication session by a particular mobile device, which mobile device will be moving from a first location to a second location and thereby traversing heterogeneous network communication resources) is able to automatically determine a monetary cost associated with supporting a communication service using heterogeneous network communication resources as that mobile device moves from the first location to the second location. By one approach, this can comprise, at least in part, automatically determining a sequence of usage of the heterogeneous network communication resources by which the communication session can be supported as the mobile device moves from the first to the second location (in which case, if desired, the step of determining the monetary cost can be made, at least in part, as a function of that sequence of usage).

By one approach, these teachings will further support, if desired, providing information regarding that monetary cost to the mobile device itself. The mobile device, in turn, can be selectively configured and arranged, if desired, to receive such information and to automatically use that information in a predetermined manner. This might comprise, for example, providing the information regarding the monetary cost to an end user of the mobile device. This might also comprise, if desired, applying at least one predetermined operational policy to determine whether to accept the monetary cost.

By one approach, the aforementioned network server can be further configured and arranged, if desired, to respond to a message from such a mobile device by automatically determining a new monetary cost to be associated with this communication session by effectively redetermining the aforementioned sequence of usage of the heterogeneous network communication resources. Such might be the case, for example, when an initial monetary cost (as corresponds to a first sequence of usage) exceeds some allowable or acceptable limit as pertains to the mobile device.

So configured, those skilled in the art will recognize and appreciate that these teachings provide an efficient and carefully leveraged application of existing system capabilities. It will further be recognized that these teachings will readily scale to accommodate, for example, essentially any number of communication networks and heterogeneous network communication resources as well as any number of mobile devices. By these teachings, the monetary cost to be associated with a given communication session that will sequentially span two or more heterogeneous network communication resources can be preliminarily ascertained and that information then applied in various ways to permit better usage and control of such resources to achieve desired end user purposes.

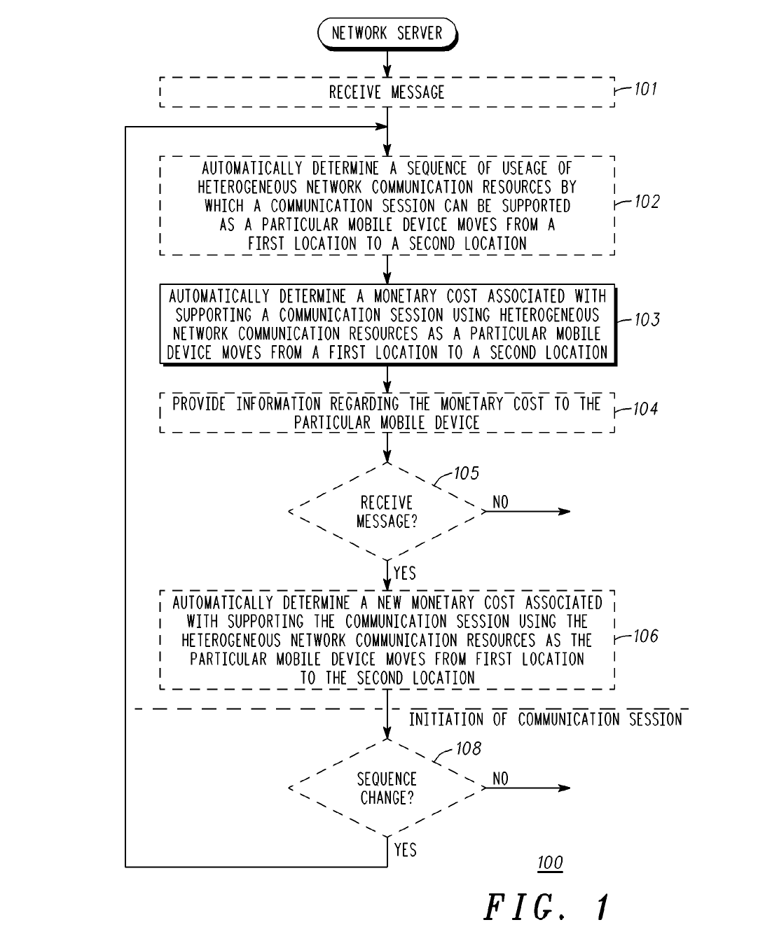

These and other benefits may become clearer upon making a thorough review and study of the following detailed description. Referring now to the drawings, and in particular to FIG. 1, an illustrative process that is compatible with many of these teachings will now be presented. This process 100 can be carried out by a network server of choice. Such a network server can comprise an independent dedicated-purpose platform, if desired, or can comprise a part of a multi-purpose platform. It would also be possible, if desired, to distribute the described network server functionality over a plurality of implementing platforms. Such architectural choices are well understood in the art and require no further elaboration here.

At the outset of this description, it may also be useful to note that many of the described steps occur prior to initiation of a communication session 107 by a particular mobile device that will itself be moving from a first location to a second location and thereby traversing heterogeneous network communication resources. As noted earlier, these heterogeneous network communication resources can be many and can vary considerably from one application setting to another. Examples include, but are certainly not limited to, transmission frequencies, channel spacing and bandwidth, time slot partitioning, spreading codes, power limitations, modulation types, pilot types, signaling protocols, and so forth.

By one approach, this process 100 will optionally provide for receiving 101 a message from a given mobile device that will be moving from a first location to a second location as noted above. This message can comprise, if desired, information regarding a first geographic location (such as a present location) of the mobile device along with information regarding a target geographic destination. For example, such information might be provided in the form of latitude and longitude, street addresses, and so forth as desired. This message can also identify, if desired, characterizing information regarding the communication session itself. This information might comprise, but is not limited to, information regarding a likely duration of the communication session, real-time transmission and/or reception requirements, bandwidth requirements, cost limitations and/or requirements, quality of service requirements, service provider preferences and/or requirements, and so forth.

Such information can then be used by the network server to automatically determine one or more specific routes by which the mobile device can move from the first location to the second location. Automated route planning of course comprises a well-understand area of endeavor and requires no further explanation here. By another approach, if desired, the above-mentioned message from the mobile device can itself specify part or all of the planned route by which the mobile device will be moving from the first location to the second location.

Regardless of whether the network server receives the information noted above in a given application setting, this process 100 will also optionally accommodate automatically determining 102 a sequence of usage of the heterogeneous network communication resources by which the communication session can be supported as the mobile device moves from the first location to the second location. Such a step may comprise, for example, using information regarding the various heterogeneous network communication resources as are available in a given geographic area to thereby permit selection of particular resources to employ at particular locations along the route to be traveled by the mobile device.

Such a sequence of usage can be based, of course, upon a wide variety of selection criteria including, but not limited to, preferences regarding cost, established administrative affiliations, coverage range, available bandwidth, handoff complexities, and other limitations and/or opportunities as may tend to characterize a given such resource in a given application setting.

Considerable detail regarding such a step can be found in an earlier filed U.S. Patent Application as filed by the present applicant and inventors, which application is entitled METHOD AND APPARATUS TO FACILITATE USING A PATH TO DYNAMICALLY SCHEDULE WIRELESS ACCESS POINT SUPPORT FOR A GIVEN COMMUNICATION SESSION and was filed on Nov. 30, 2006 as application Ser. No. 11/564,950, the contents of which are fully incorporated herein by this reference.

Such a sequence of usage can comprise, for example, scheduling handoffs of the communication session between access points (and particularly between access points as comprise parts of differing heterogeneous communication networks). This, in turn, can further comprise scheduling such handoffs as a function of a monetary cost policy in this regard. For example, when two (or more) different handoff options exist with respect to a given route, the handoff representing a lower transaction cost may be selected in keeping with a preference in that regard.

In any event, and regardless of how otherwise occasioned, this process 100 then provides for automatically determining 103 a monetary cost associated with supporting the communication session using heterogeneous network communication resources as the mobile device moves from the first location to the second location. This can comprise, for example, though is not limited to, automatically determining a monetary cost as a function, at least in part, of the aforementioned sequence of usage. By one approach, for example, this can comprise summing and aggregating the various costs that correspond to each of the heterogeneous network communication resources.

If desired, these steps can readily accommodate determining various monetary costs as correspond to various route and handoff options as may be present in a given setting. This approach, in turn, would facilitate vetting options in these regards to thereby identify, for example, a least expensive route by which the mobile device can move from the first to the second location while still engaging in the desired communication session.

By one approach, for example, such information could be used to simply confirm or deny the request of the mobile device to establish the aforementioned communication service. For example, when the least expensive acceptable sequence of usage still nevertheless exceeds some predetermined monetary limit as may be been established by an end user of (or administrator for) the mobile device, the requested service may simply be denied.

By another approach, if desired, this process 100 will further optionally provide for providing 104 information regarding the monetary cost to the particular mobile device. This might comprise, for example, providing information to indicate generally that the monetary cost is greater than, or less than, some predetermined limit, threshold, or other amount. This could also comprise, in combination with such an approach or in lieu thereof, providing the actual monetary cost itself to the mobile device. In any of these cases, this information could be provided in a corresponding message as can be transmitted to the mobile device using whatever signaling protocol or format may be available and appropriate for such usage in a given application setting as will be well understood by those skilled in the art.

In such a case, and as will be described in more detail below, the network server may subsequently detect 105 reception of a corresponding message from the mobile device to which the aforementioned monetary cost information had been sent. As with the latter message, this message from the mobile device can be in whatever form and format as may correspond to the requirements and/or opportunities as correspond to a given application setting as will be well understood by those skilled in the art. Such a message, for example, can comprise a response or reaction to the monetary cost. (When the reception of such a message does not occur, of course, the process can otherwise continue in whatever manner may be determined to be appropriate to suit the needs of a given application setting.)

When this message comprises a negative reaction to the earlier determined monetary cost, this process 100 will accommodate optionally automatically determining 106 a new monetary cost associated with supporting the communication session at issue. This can comprise, for example, determining a new monetary cost as a function, at least in part, of considering an alternative sequence of usage of the heterogeneous network communication resources by which the communication session can be supported as the particular mobile device moves from the first location to the second location. This can comprise an alternative sequence as may have already been considered by the network server but which had been previously unfavored due to some other selection criteria (such as, for example, a preference for initially selecting a shortest route between a starting and ending location). This can also comprise, if desired, considering a new sequence that had not been previously considered.

By one approach, the network server can consider such alternative sequences in a relatively open loop manner with little or no substantive input from the mobile device in this regard. By another approach, if desired, the mobile device can provide substantive guidance such as, but not limited to, suggestions or instructions regarding a particular route to be considered, a particular administrative domain to be favored, and/or specific performance criteria that can be relaxed as compared to earlier stipulations and/or preferences of record, to note but a few examples in this regard.

If desired, the aforementioned steps can be repeated as desired. For example, a redetermined monetary cost can again be communicated to the mobile device following which the latter can again signal its acceptance or refusal. When the redetermined monetary cost again proves unsatisfactory, the monetary cost can again be redetermined by considering, for example, yet another sequence of usage of the heterogeneous network communication resources. These teachings will also accommodate, if desired, providing in a single communication session to the mobile device information regarding monetary costs as correspond to a plurality of candidate sequences of usage. In such a case, the mobile device could then respond, if desired, by indicating a particular one of the sequences/costs to be used when supporting the requested communication session.

Upon eventually settling upon a particular monetary cost, the communication session can be initiated 107. This monetary cost, of course, may be dependent upon a particular sequence of usage of the available heterogeneous network communication resources. In some cases, the real time experience of the mobile device may deviate, and perhaps considerably, from the planned and anticipated sequence of usage. Such variations may be with respect to the route itself and/or with respect to the anticipated times during which the mobile device uses such resources. In such cases, of course, the earlier determinations regarding monetary cost may become obsolete.

To accommodate such a circumstance, if desired, these teachings will also optionally provide for detecting 108 such an experiential change with respect to the sequence of usage. Upon detecting such a change, for example, this process 100 can provide for now determining a new monetary cost as based upon an updated projection of the costs of supporting the then ongoing communication session as the mobile device traverses the various heterogeneous network communication resources. As before, if desired, this can also include providing updated monetary cost information to the mobile device. Such information can serve to inform, for example, decisions regarding whether to continue the communication session, to alter in some specific manner the route by which the mobile device moves from the first to the second location, and so forth. (When such an experiential change does not occur, of course, the process can otherwise continue in whatever manner may be determined to be appropriate to suit the needs of a given application setting.)

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example, the network server 200 comprises, at least in relevant part, a processor 201 that operably couples to a communication interface 202. The latter, in turn, serves to communicatively couple the network server 200 to one or more networks 203 and hence to various heterogeneous network communication resources 204 as well as the aforementioned mobile device 205. So configured and arranged, the processor 201 of the network server 200 is able to communicate with the heterogeneous network communication resources 204 and the mobile device 205 to better facilitate carrying out the various actions and functionality described herein.

By one approach, this processor 201 is configured and arranged to carry out one or more of the steps, actions, and/or functionality described herein. This can comprise, but is not limited to, automatically determining a monetary cost associated with supporting a communication session for a mobile device that will move from a first location to a second location and while using various heterogeneous network communication resources to support that communication session as described herein. This can also comprise, as desired, participating in the various informational exchanges with the mobile device as are described herein.

Such a processor 201 can comprise, as desired, a dedicated purpose platform or can comprise a partially or wholly programmable platform. Such architectural choices are well known and understood in the art and require no further elaboration here.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

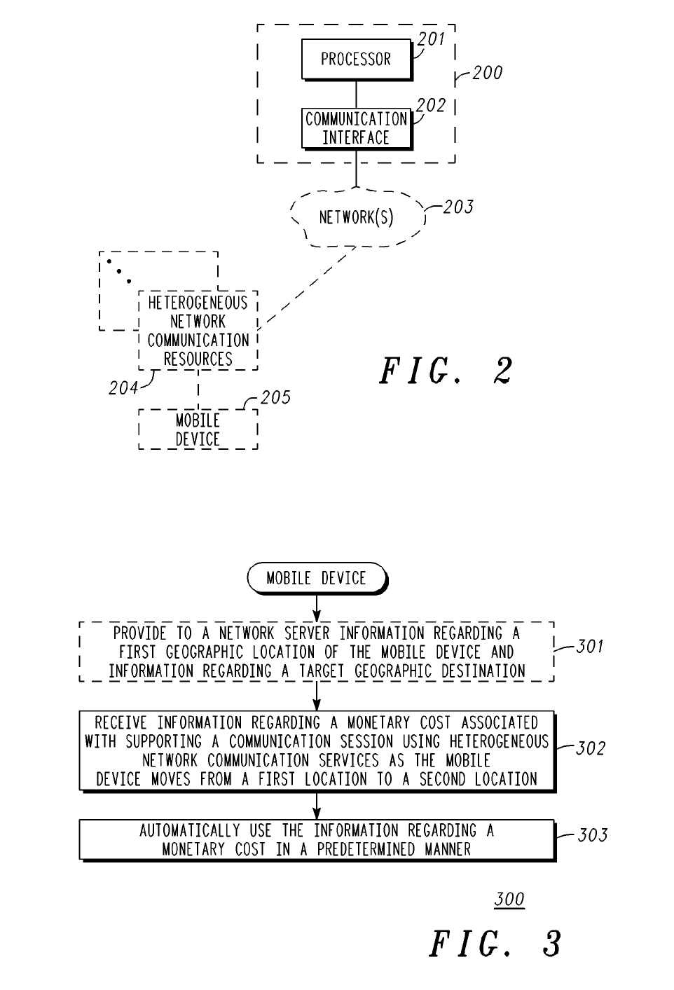

If desired, and as alluded to above, a mobile device can play varying passive or active roles during such activities. Referring now to FIG. 3, some corresponding optional processes 300 as correspond to a mobile device will be described.

By one approach, such a process 300 can optionally provide for providing 301 to the network server information regarding a first geographic location (such as, but not limited to, a present geographic location) and/or information regarding a target geographic destination. Such information can then be used by the network server as described above to permit the automated determination of a monetary cost associated with supporting a communication session for the mobile device with various heterogeneous network communication resources as the mobile device moves from the first location to the second location. This step 301 can also comprise, if desired, providing information regarding an anticipated or scheduled start-time and/or stop-time for the communication session, bandwidth requirements, quality of service requirements, administrative domain preferences, physical layer preferences, and so forth.

This process 300 can then provide for receiving 302 information from the network server regarding a monetary cost associated with supporting such a communication session using such heterogeneous network communication resources during such movement. As noted above, this information can assume any of a wide variety of forms and informational content to suit the needs and/or opportunities as correspond to a given application setting.

This process 300 can also provided for automatically using 303 such information regarding a monetary cost in a predetermined manner. By one approach, for example, this can comprise providing the information regarding the monetary cost to an end user of the mobile device. This may be accomplished in various ways as will be well understood by this skilled in art. By one approach this can comprise providing the information in visual form via, for example, a display. By another approach this can comprise providing the information in audible form (using, for example, pre-recorded speech messages, synthesized speech, and so forth).

This usage per a predetermined manner can also comprise, if desired, applying at least one predetermined operational policy to determine whether to accept the monetary cost. As one simple illustration in this regard, this can comprise comparing the monetary cost amount with a maximum permitted threshold value. By one approach, when the monetary cost exceeds this threshold value, the mobile device can automatically communicate a corresponding refusal to the network server as described above. By another approach, when the monetary amount exceeds such a threshold value, the mobile device can then provide an alert to the end user to permit the latter an opportunity to accept or to refuse the desired service on such a basis.

So configured, it becomes economically and technologically possible and useful to predetermine monetary costs as will correspond to the usage of various heterogeneous network communication resources when supporting a subsequent communication for a mobile device that traverses the coverage areas of such resources. This information, in turn, can be used by the network server and/or the mobile device in various ways to facilitate improved allocation and/or usage of such resources in favor of a particular mobile device.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a network server and prior to initiation of a communication session by a particular mobile device, which mobile device will be moving from a first location to a second location and thereby traversing heterogeneous network communication resources:
automatically determining a monetary cost associated with supporting the communication session using the heterogeneous network communication resources as the particular mobile device moves from the first location to the second location.

2. The method of claim 1 further comprising:
automatically determining a sequence of usage of the heterogeneous network communication resources by which the communication session can be supported as the particular mobile device moves from the first location to the second location.

3. The method of claim 2 wherein automatically determining a monetary cost associated with supporting the communication session using the heterogeneous network communication resources as the particular mobile device moves from the first location to the second location further comprises automatically determining the monetary cost as a function, at least in part, of the sequence of usage.

4. The method of claim 2 wherein automatically determining a sequence of usage of the heterogeneous network communication resources by which the communication session can be supported as the particular mobile device moves from the first location to the second location further comprises, at least in part, scheduling handoffs of the communication session between access points.

5. The method of claim 4 wherein scheduling handoffs of the communication session between access points comprises, at least in part, scheduling the handoffs as a function of a monetary cost policy.

6. The method of claim 1 further comprising:
providing information regarding the monetary cost to the particular mobile device.

7. The method of claim 6 further comprising:
upon receiving a message from the particular mobile device in response to having provided the information regarding the monetary cost, automatically determining a new monetary cost associated with supporting the communication session using the heterogeneous network communication resources as the particular mobile device moves from the first location to the second location.

8. The method of claim 7 wherein automatically determining a new monetary cost associated with supporting the communication session using the heterogeneous network communication resources as the particular mobile device moves from the first location to the second location comprises, at least in part, automatically determining a new monetary cost associated with supporting the communication session using the heterogeneous network communication resources as the particular mobile device moves from the first location to the second location as a function of an alternative sequence of usage of the heterogeneous network communication resources by which the communication session can be supported as the particular mobile device moves from the first location to the second location.

9. A network server comprising:
a communication interface;
a processor operably coupled to the communication interface, wherein the processor is configured and arranged to, prior to initiation of a communication session by a particular mobile device, which mobile device will be moving from a first location to a second location and thereby traversing heterogeneous network communication resources, automatically determine a monetary cost associated with supporting the communication session using the heterogeneous network communication resources as the particular mobile device moves from the first location to the second location.

10. The network server of claim 9 wherein the processor is further configured and arranged to automatically determine a sequence of usage of the heterogeneous network communication resources by which the communication session can be supported as the particular mobile device moves from the first location to the second location.

11. The network server of claim 10 wherein the processor is further configured and arranged to automatically determine a monetary cost associated with supporting the communication session using the heterogeneous network communication resources as the particular mobile device moves from the first location to the second location by automatically determining the monetary cost as a function, at least in part, of the sequence of usage.

12. The network server of claim 9 wherein the processor is further configured and arranged to provide information regarding the monetary cost to the particular mobile device.

13. The network server of claim 12 wherein the processor is further configured and arranged to, upon receiving a message from the particular mobile device in response to having provided the information regarding the monetary cost, automatically determine a new monetary cost associated with supporting the communication session using the heterogeneous network communication resources as the particular mobile device moves from the first location to the second location.

14. The network server of claim 13 wherein the processor is further configured and arranged to automatically determine a new monetary cost associated with supporting the communication session using the heterogeneous network communication resources as the particular mobile device moves from the first location to the second location by, at least in part, automatically determining a new monetary cost associated with supporting the communication session using the heterogeneous network communication resources as the particular mobile device moves from the first location to the second location as a function of an alternative sequence of usage of the heterogeneous network communication resources by which the communication session can be supported as the particular mobile device moves from the first location to the second location.

15. A method comprising: at a mobile device and prior to initiation of a communication session by the mobile device, which mobile device will be moving from a first location to a second location and thereby traversing heterogeneous network communication resources:
receiving information regarding a monetary cost associated with supporting the communication session using the heterogeneous network communication resources as the mobile device moves from the first location to the second location;
automatically using the information regarding a monetary cost in a predetermined manner.

16. The method of claim 15 further comprising:
providing to a network server information regarding a first geographic location of the mobile device and information regarding a target geographic destination, such that the network server can use the information regarding the first geographic location and the target geographic destination to automatically determine a monetary cost associated with supporting the communication session using the heterogeneous network communication resources as the mobile device moves from the first location to the second location.

17. The method of claim 15 wherein automatically using the information regarding a monetary cost in a predetermined manner comprises, at least in part, providing the information regarding the monetary cost to an end user of the mobile device.

18. The method of claim 15 wherein automatically using the information regarding a monetary cost in a predetermined manner comprises, at least in part, applying at least one predetermined operational policy to determine whether to accept the monetary cost.
